(19) United States
(12) Patent Application Publication
(10) Pub. No.: US 2010/0118576 A1
(43) Pub. Date: May 13, 2010

(54) POWER FACTOR CORRECTION CIRCUIT

(75) Inventor: Shohei Osaka, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SANKEN ELECTRIC CO., LTD., NIIZA-SHI (JP)

(21) Appl. No.: 12/598,045

(22) PCT Filed: Apr. 21, 2008
(86) PCT No.: PCT/JP2008/057677

§ 371 Date: Oct. 29, 2009

(30) Foreign Application Priority Data
May 1, 2007 (JP) 2007-121138

(51) Int. Cl. H02M 7/06

(52) U.S. Cl. 363/126

(57) ABSTRACT

A power factor correction circuit includes a rectifier 3 to rectify an AC voltage of an AC power source 1, a first series circuit connected in parallel with an output of the rectifier and having a step-up reactor L1 and a switching element Q0 that are connected in series, a second series circuit connected in parallel with the switching element and having a rectifying diode D1 and a smoothing capacitor C2 that are connected in series, an oscillation circuit 12 to generate a clock signal CLK having a predetermined oscillation frequency, and a control circuit 10 to generate, at the period of the clock signal generated by the oscillation circuit and according to a voltage value of the smoothing capacitor, a drive signal for driving the switching element. The oscillation circuit changes the predetermined frequency according to the drive signal for the switching element.

### TECHNICAL FIELD

The present invention relates to a step-up-type power factor correction circuit having a power factor correction function.

### BACKGROUND TECHNOLOGY

Converting an AC voltage of an AC power source into a DC voltage through a rectifier and smoothing capacitor results in distorting an input current and deteriorating a power factor. For this, a step-up chopper circuit consisting of a step-up reactor, a switching element, a rectifying diode, and a smoothing capacitor is connected to an output of the rectifier, to form a power factor correction circuit to reduce the distortion of an input current.

A control method for the power factor correction circuit may be a DCM (Discontinuous Conduction Mode) method that turns on the switching element for a predetermined period to pass a current through the step-up reactor, detects that the current passing through the step-up reactor is zeroed after the switching element turns off, and again turns on the switching element, or a CCM (Continuous Conduction Mode) method that carries out PWM control at predetermined intervals without regard to a current passing through the step-up reactor.

FIG. 1 is a view illustrating a power factor correction circuit according to a related art. The power factor correction circuit illustrated in FIG. 1 is of the CCM method and includes an AC power source 1, a filter 2 to remove electromagnetic noise contained in the AC power source, a full-wave rectifier 3 to rectify an AC voltage of the AC power source 1 via the filter 2, and a smoothing capacitor C1 to smooth the rectified voltage from the full-wave rectifier 3.

Both ends of the smoothing capacitor C1 are connected to a first series circuit of a step-up reactor L1, a switching element Q0 made of, for example, a MOSFET, and a resistor R3. Between the drain and source of the switching element Q0, there is connected a second series circuit of a diode D1 and a smoothing capacitor C2. Both ends of a series circuit having the step-up reactor L1 and diode D1 are connected to a diode D2, and both ends of the smoothing capacitor C2 are connected to a series circuit of resistors R1 and R2.

A control circuit 10a has an oscillation circuit 11 to generate a clock signal having a predetermined oscillation frequency and a PWM control unit 14. The voltage of the smoothing capacitor C2 is divided by the resistors R1 and R2 and the divided voltage is inputted to a terminal VSE of the PWM control unit 14. The PWM control unit 14 generates an error signal representative of an error between the voltage at the terminal VSE and a reference voltage, generates a triangular signal at a period of the clock signal CLK outputted from the oscillation circuit 11, and compares the generated triangular signal and error signal with each other, to generate a PWM signal that turns on/off the switching element Q0.

Both ends of the smoothing capacitor C1 are connected to a series circuit of resistors R6 and R7, and a connection point of the resistors R6 and R7 is connected through a terminal ADJ of the control circuit 10a to the oscillation circuit 11.

The resistor R3 is a detection resistor that detects a current passing through the step-up reactor L1 and provides protection against an overcurrent. Namely, a voltage drop corresponding to a current passing through the resistor R3 is inputted through a resistor R4 to the PWM control unit 14, so that the PWM control unit 14 provides protection against an overcurrent according to the voltage of the resistor R4.

Operation of the conventional power factor correction circuit having such a configuration will be explained. When the switching element Q0 turns on, a current passes clockwise through a path extending along the AC power source 1, filter 2, full-wave rectifier 3, step-up reactor L1, switching element Q0, resistor R3, full-wave rectifier, filter 2, and AC power source 1, to accumulate energy in the step-up reactor L1.

When the switching element Q0 turns off, a current passes clockwise through a path extending along the AC power source 1, filter 2, full-wave rectifier 3, step-up reactor L1, rectifying diode D1, smoothing capacitor C2 (and load (not illustrated)), resistor R3, full-wave rectifier 3, filter 2, and AC power source 1. Due to discharge of the energy accumulated in the step-up reactor L1 and the AC power source 1, the smoothing capacitor C2 is charged and energy is supplied to the load.

A PWM signal from the PWM control unit 14 again turns on the switching element Q0, to pass a current clockwise through the path extending along the AC power source 1, filter 2, full-wave rectifier 3, step-up reactor L1, switching element Q0, resistor R3, full-wave rectifier, filter 2, and AC power source 1. At this time, an anode of the rectifying diode D1 has a potential of the minus side of the smoothing capacitor C2, and therefore, the voltage of the smoothing capacitor C2 is applied to the rectifying diode D1 in a reverse direction.

### DISCLOSURE OF INVENTION

When the power factor correction circuit of the CCM method outputs power equal to or larger than a predetermined level determined by the inductance of the step-up reactor L1, an ON period of the switching element Q0, a voltage applied to the step-up reactor L1, and the like, a current passing through the step-up reactor L1 causes a direct-current-superposed state to always pass a current through the step-up reactor L1. If the step-up reactor L1 causes the direct-current-superposed state, the switching element Q0 turns on when a current is supplied from the step-up reactor L1 to the rectifying diode D1. Then, the rectifying diode D1 passes a recovery current because a voltage is suddenly applied thereto in a reverse direction from an ON state. Although the recovery current is a short pulse current, it is large, and therefore, produces noise. To suppress the noise, a snubber circuit is generally arranged in parallel with the rectifying diode D1.

In the power factor correction circuit of the related art illustrated in FIG. 1, a voltage across the smoothing capacitor C1 is divided by the resistors R6 and R7 and the divided voltage is inputted through the terminal ADJ of the control circuit 10a to the oscillation circuit 11. According to the voltage from the terminal ADJ, the oscillation circuit 11 changes an oscillation frequency. Accordingly, the frequency of the PWM signal to the switching element Q0 changes in proportion to the voltage of the terminal ADJ, i.e., the voltage of the AC power source 1, to disperse the frequency of the generated noise and thereby suppress the noise.

Conventional power factor correction circuits similar to the power factor correction circuit illustrated in FIG. 1 are disclosed in, for example, U.S. Pat. No. 5,459,392 (Patent Document 1) and U.S. Pat. No. 7,123,494 (Patent Document 2).

### Means to Solve the Problems

To suppress the noise generated in the power factor correction circuit of the CCM method, the technique of arranging a snubber circuit in parallel with the rectifying diode D1 is simple and effective. However, it converts energy that causes the noise into heat by the snubber circuit, and therefore, increases heat generation and deteriorates efficiency.

In the power factor correction circuit described in any one of the Patent Document 1, Patent Document 2, and FIG. 1, the voltage of the AC power source 1 is used to change the oscillation frequency of the control circuit 10a. This technique can suppress noise without lowering efficiency. However, directly detecting the high AC voltage of the Ac power source 1 causes a relatively large detection loss. In addition, the control circuit 10a should additionally have the terminal ADJ, so that the power factor correction circuit is hardly integrated into an IC (integrated circuit).

The present invention is able to provide a power factor correction circuit that is capable of diffusing generated noise, improving efficiency, and simplifying structure.

To solve the problems mentioned above, a first technical aspect of the present invention provides a power factor correction circuit including a rectifier to rectify an AC voltage of an AC power source, a first series circuit connected in parallel with an output of the rectifier and having a step-up reactor and a switching element those are connected in series, a second series circuit connected in parallel with the switching element and having a rectifying diode and a smoothing capacitor that are connected in series, an oscillator to generate a clock signal having a predetermined oscillation frequency, and a control circuit to generate, at a period of the clock signal generated by the oscillator and according to a voltage value of the smoothing capacitor, a drive signal for driving the switching element. The oscillator changes the predetermined frequency according to the drive signal for the switching element.

According to a second technical aspect of the present invention, the oscillator includes an oscillation capacitor, a signal generator to generate the clock signal having a predetermined oscillation frequency by repeatedly charging and discharging the oscillation capacitor, and a frequency controller to change the predetermined oscillation frequency of the clock signal of the signal generator by increasing or decreasing, according to the drive signal for the switching element, at least one of charging and discharging currents for the oscillation capacitor by a predetermined value.

### BRIEF DESCRIPTION OF DRAWINGS

FIG. 1 is a view illustrating a power factor correction circuit according to a related art.

FIG. 2 is a view illustrating a power factor correction circuit according to Embodiment 1 of the present invention.

FIG. 3 is a view illustrating an oscillation circuit arranged in the power factor correction circuit according to Embodiment 1 of the present invention.

FIG. 4 is a waveform diagram illustrating operation of the power factor correction circuit according to Embodiment 1 of the present invention.

FIG. 5 is a view illustrating an oscillation circuit arranged in a power factor correction circuit according to Embodiment 2 of the present invention.

FIG. 6 is a waveform diagram illustrating operation of the power factor correction circuit according to Embodiment 2 of the present invention.

FIG. 7 is a view illustrating an oscillation circuit arranged in a power factor correction circuit according to Embodiment 3 of the present invention.

### BEST MODE OF IMPLEMENTING INVENTION

The power factor correction circuits according to the embodiments of the present invention will be explained in detail with reference to the drawings.

### Embodiment 1

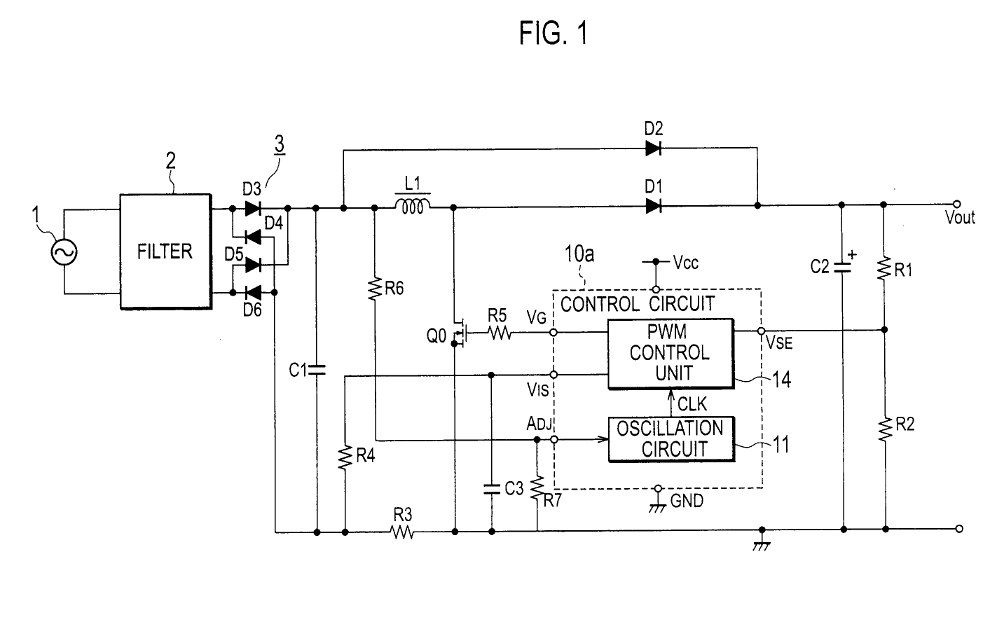

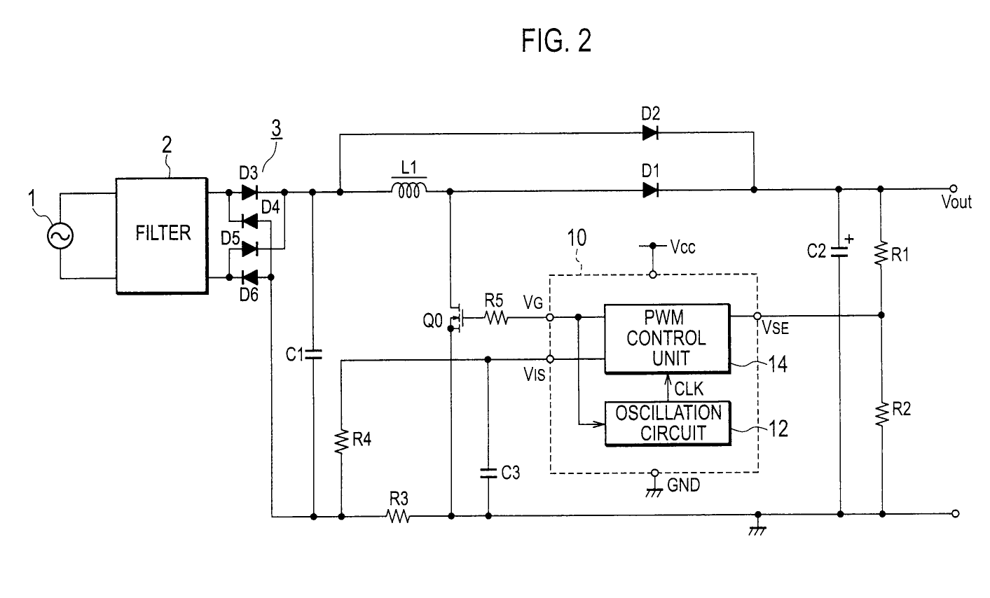

FIG. 2 is a view illustrating the power factor correction circuit according to Embodiment 1 of the present invention. The power factor correction circuit of Embodiment 1 illustrated in FIG. 2 is characterized in that, compared with the power factor correction circuit of the related art illustrated in FIG. 1, the resistors R6 and R7 connected to the output of the full-wave rectifier 3 are omitted and an output terminal VG of a PWM control unit 14 and an oscillation circuit 12 are connected to each other.

The oscillation circuit 12 generates a clock signal having a predetermined oscillation frequency, receives a PWM signal for a switching element Q0 from the output terminal VG of the PWM control unit 14, and according to the PWM signal, changes the predetermined oscillation frequency of the clock signal.

The PWM control unit 14 generates, at a period of the clock signal generated by the oscillation circuit 12 and according to a voltage value of a smoothing capacitor C2, the PWM signal to turn on/off the switching element Q0.

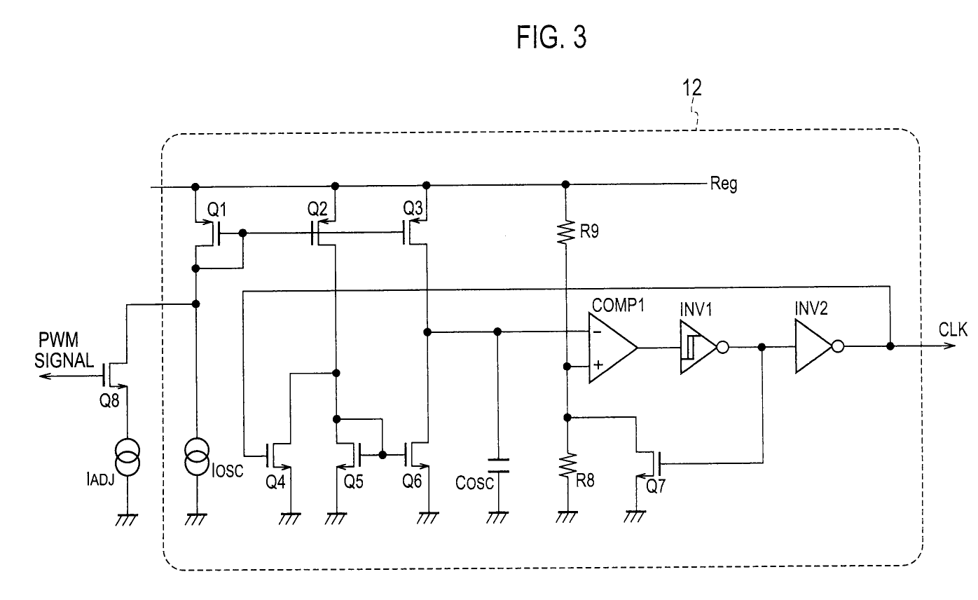

FIG. 3 is a view illustrating the oscillation circuit arranged in the power factor correction circuit according to Embodiment 1 of the present invention. In FIG. 3, connected between a power source Reg and the ground is a series circuit having an FET Q1 and a constant current source Iosc. Both ends of the constant current source Iosc are connected to a series circuit having an FET Q8 and a constant current source IADJ. Connected between the power source Reg and the ground are a series circuit having FETs Q2 and Q5 and a series circuit having FETs Q3 and Q6. Both ends of the FET Q5 are connected to an FET Q4.

A connection point of the FETs Q3 and Q6 is connected to an oscillation capacitor Cosc and a minus terminal (depicted by “−”) of a comparator COMP1. Connected between the power source Reg and the ground is a series circuit having resistors R8 and R9. A connection point of the resistors R8 and R9 is connected to a positive terminal (depicted by “+”) of the comparator COMP1.

An output terminal of the comparator COMP1 is connected to an input terminal of an inverter INV1. An output terminal of the inverter INV1 is connected to an input terminal of an inverter INV2 and a gate of an FET Q7. Connected between the drain and source of the FET Q7 are both ends of the resistor R8. An output terminal of the inverter INV2 outputs the clock signal and is connected to a gate of an FET Q4. A gate of the FET Q8 receives the PWM signal from the PWM control unit 14.

The comparator COMP1, resistors R8 and R9, and FET Q7 determine a charging/discharging operation of the oscillation capacitor Cosc. The inverters INV1 and INV2 and FETs Q4 and Q7 switch the charging/discharging operation of the oscillation capacitor Cosc. The FETs Q1 and Q3 form a first current mirror circuit, so that a current of the constant current source Iosc passes through the FET Q3, to charge the oscillation capacitor Cosc. The FETs Q5 and Q6 form a second current mirror circuit, so that a current n times (n being an optional numeric value equal to or larger than 1) as large as the current of the constant current source Iosc passes through the FET Q6, to discharge the oscillation capacitor Cosc. The FET Q8 and constant current source IADJ form the frequency control unit of the present invention.

The configuration illustrated in FIG. 3 excluding the FET Q8 and constant current source IADJ forms the signal generation unit of the present invention.

Operation of the power factor correction circuit of Embodiment 1 constituted as mentioned above, in particular, operation of the oscillation circuit 12 will be explained in detail.

A state in which the FET Q8 is OFF will be explained. If the oscillation capacitor Cosc is not charged, the comparator COMP1 outputs H-level. The inverter INV1 outputs L-level, and therefore, the FET Q7 turns off and both ends of the resistor R8 generate a voltage obtained by dividing the voltage Reg by the resistors R8 and R9. This voltage is inputted as a first threshold value to the positive terminal of the comparator COMP1. The inverter INV2 outputs H-level, and therefore, the FET Q4 turns on and the second current mirror circuit passes no current through the FET Q6.

When a current of the constant current source Iosc passes through the FET Q1, the current of the constant current source Iosc is also passes through the FET Q3 of the first current mirror circuit, and therefore, the oscillation capacitor Cosc is charged with the current of the constant current source Iosc. When the voltage of the oscillation capacitor Cosc reaches the first threshold value, the comparator COMP1 inverts its output to L-level. At the same time, the inverter INV1 becomes H-level to turn on the FET Q7. As results, the positive terminal of the comparator COMP1 receives a second threshold value that is lower than the first threshold value and the output of the comparator COMP1 keeps L-level.

The inverter INV2 becomes L-level to turn off the FET Q4, so that the second current mirror circuit is enabled to pass a current through the FET Q6. Then, a differential current (IQ3−IQ6) between a current IQ3 of the FET Q3 and a current IQ6 of the FET Q6 discharges the oscillation capacitor Cosc. Due to this, the FET Q6 receives the current of the FET Q3 and the discharging current of the oscillation capacitor Cosc.

When the voltage of the oscillation capacitor Cosc decreases to the second threshold value, the comparator COMP1 inverts its output to H-level. At the same time, the inverter INV1 becomes L-state to turn off the FET Q7. Since the positive terminal of the comparator COMP1 increases to the first threshold voltage, the output of the comparator COMP1 keeps H-level. Since the inverter INV2 becomes H-level, the FET Q4 turns on and the second current mirror circuit passes no current through the FET Q6. Accordingly, the oscillation capacitor Cosc is again charged with the current of the constant current source Iosc. The above-mentioned operations are repeated, to output the clock signal CLK.

According to Embodiment 1, the gate of the FET Q8 receives the PWM signal (the signal to drive the switching element Q0) from the PWM control unit 14. When the PWM signal is H-level (when the switching element Q0 is being driven), a current passing through the FET Q1 of the first current mirror circuit is the sum of the currents of the constant current source Iosc and constant current source IADJ.

The oscillation capacitor Cosc is charged with a current passing through the FET Q3 of the first current mirror circuit (same as the current of the FET Q1), and therefore, the voltage of the oscillation capacitor Cosc more quickly reaches the first threshold value by an increased portion of the charging current. This results in increasing the oscillation frequency of the clock signal CLK outputted from the oscillation circuit 12. If the H-level period of the PWM signal is elongated, the current for charging the capacitor Cosc is increased by the elongated portion, to further increase the oscillation frequency.

When the H-level period of the PWM signal becomes a discharge period of the oscillation capacitor Cosc, the oscillation capacitor Cosc is discharged by the discharging current (IQ3−IQ6). The current passing through the FET Q6 is set to be greater than the current passing through the FET Q3 by a predetermined magnification ratio, and therefore, the discharging time becomes shorter to further increase the frequency.

In this way, Embodiment 1 increases the charging current and discharging current of the oscillation capacitor Cosc during a H-level period of the PWM signal, to change the frequency of the clock signal CLK of the oscillation circuit 12.

Generally, the power factor correction circuit of the CCM method detects the voltage of the smoothing capacitor C2 and the voltage of the AC power source 1 (an output from the full-wave rectifier 3), controls the voltage of the smoothing capacitor C2 at a constant value, and equalizes the input current waveform and input voltage waveform of the AC power source 1 to each other by PWM-controlling the switching element Q0 at a fixed frequency. Accordingly, the duty ratio of the PWM signal is changed according to an input voltage.

Namely, when the input voltage Vin of the AC power source 1 is around zero, the ON time of the switching element Q0 (the H-level period of the PWM signal) becomes longer, and when the input voltage Vin of the AC power source 1 is around a peak, the ON time of the switching element Q0 (the H-level period of the PWM signal) becomes shorter. Accordingly, the oscillation circuit 12 of Embodiment 1 can change the frequency of the output signal CLK according to the AC voltage of the AC power source 1.

In this way, the control circuit 10 generates the PWM signal at a period of the output signal CLK of the oscillation circuit 12, and therefore, the switching element Q0 driven by the PWM signal turns on/off at the frequency that changes according to the voltage of the AC power source 1. This results in dispersing frequency components of noise, reducing noise, and improving efficiency. The resistors R6 and R7 and the terminal ADJ are omitted, and therefore, the power factor correction circuit becomes simpler.

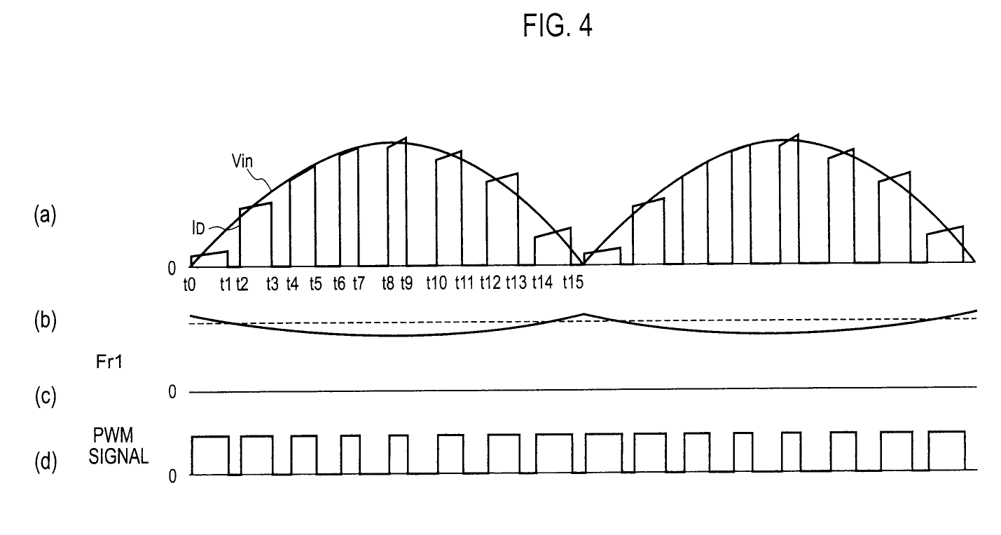

FIG. 4 is a waveform diagram illustrating operation of the power factor correction circuit according to Embodiment 1 of the present invention. In FIG. 4, Vin is an output waveform of the full-wave rectifier 3, ID is a drain current of the switching element Q0, Fr1 is the frequency of the clock signal CLK of the oscillation circuit 12, and PWM signal is the PWM signal outputted from the control circuit 10.

In FIG. 4, when the voltage Vin of the AC power source 1 is around zero, the duty ratio of the PWM signal is large and the frequency Fr1 of the clock signal CLK is high. When the voltage Vin of the AC power source 1 is around a peak value, the duty ratio of the PWM signal is small and the frequency Fr1 of the clock signal CLK is low.

### Embodiment 2

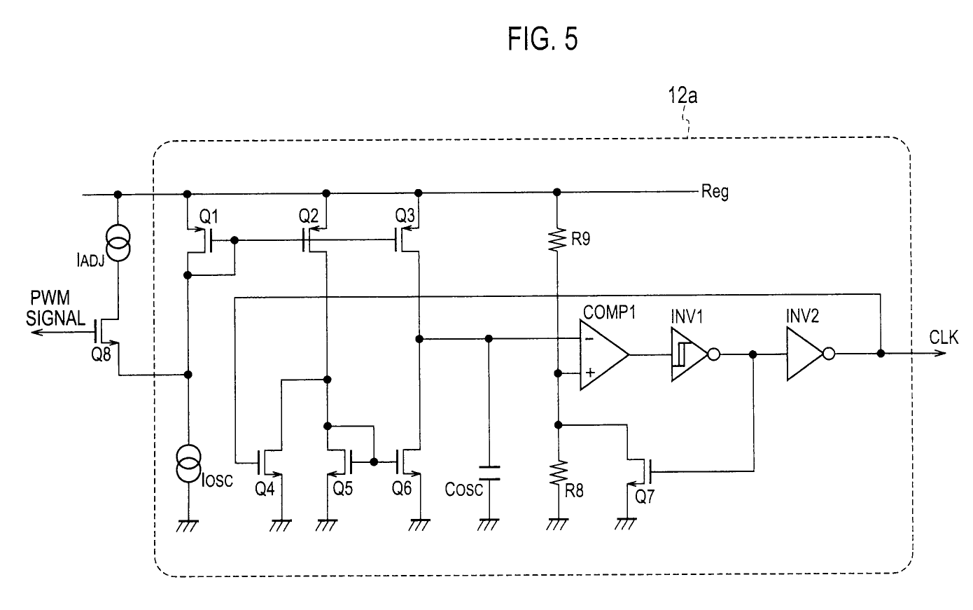

FIG. 5 is a view illustrating an oscillation circuit arranged in a power factor correction circuit according to Embodiment 2 of the present invention. The oscillation circuit 12a of Embodiment 2 is characterized in that a series circuit having an FET Q8 and a constant current source IADJ is connected in parallel with an FET Q1. The remaining configuration of the oscillation circuit 12a illustrated in FIG. 5 is the same as that of the oscillation circuit of Embodiment 1 illustrated in FIG. 3, and therefore, the same parts are represented with the same reference marks to omit the explanations thereof.

Like Embodiment 1, an FET Q3 provides a current equal to a current passing through the FET Q1, and this current charges an oscillation capacitor Cosc. When an FET Q4 is OFF, an FET Q6 provides a current that is larger than the current passing through the FET Q3 by a predetermined magnification ratio, to discharge the oscillation capacitor Cosc.

When the FET Q8 turns off, the FET Q1 receives a current from a constant current source Iosc. When a PWM signal turns on the FET Q8, the FET Q1 receives a differential current (Iosc−IADJ) between the current of the constant current source Iosc and the current of the constant current source IADJ. Namely, Embodiment 2 decreases the current for charging/discharging the oscillation capacitor Cosc when the FET Q8 turns on.

As results, if the H-level period of the PWM signal is long, the charging/discharging period of the oscillation capacitor Cosc becomes longer and the frequency of the clock signal CLK becomes lower. A control circuit 10 generates the PWM signal at a period of the clock signal CLK of the oscillation circuit 12a, and therefore, the switching element Q0 driven by the PWM signal turns on/off at the frequency that changes according to an input voltage Vin of the AC power source 1. Consequently, frequency components of noise are dispersed, noise is reduced, and efficiency improves, to provide the same effect as that provided by Embodiment 1.

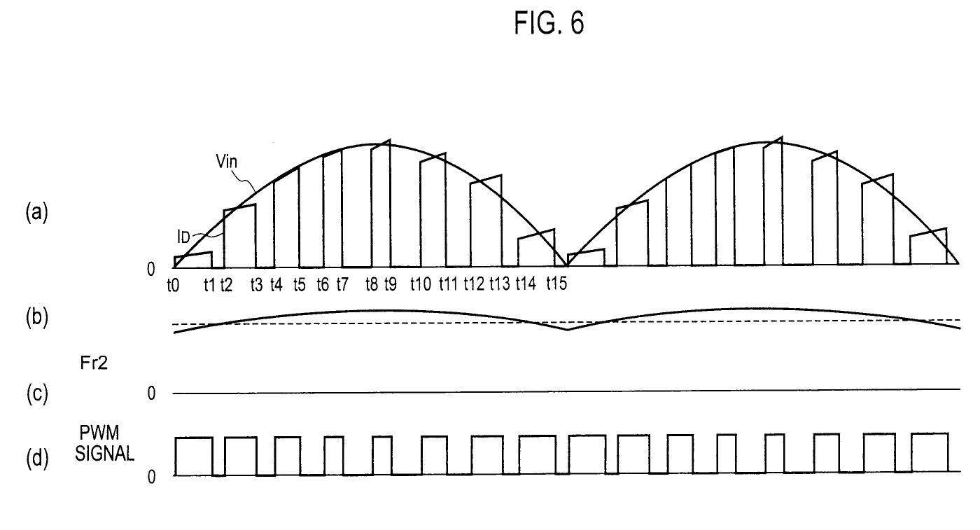

FIG. 6 is a waveform diagram illustrating operation of the power factor correction circuit according to Embodiment 2 of the present invention. In FIG. 6, Vin is an output waveform of a full-wave rectifier 3, ID is a drain current of the switching element Q0, Fr2 is the frequency of the clock signal CLK of the oscillation circuit 12a, and PWM signal is the PWM signal outputted from the control circuit 10.

In FIG. 6, when the voltage Vin of the AC power source 1 is around zero, the duty ratio of the PWM signal is large and the frequency Fr2 of the clock signal CLK is low. When the voltage Vin of the AC power source 1 is around a peak, the duty ratio of the PWM signal is small and the frequency Fr1 of the clock signal CLK is high.

### Embodiment 3

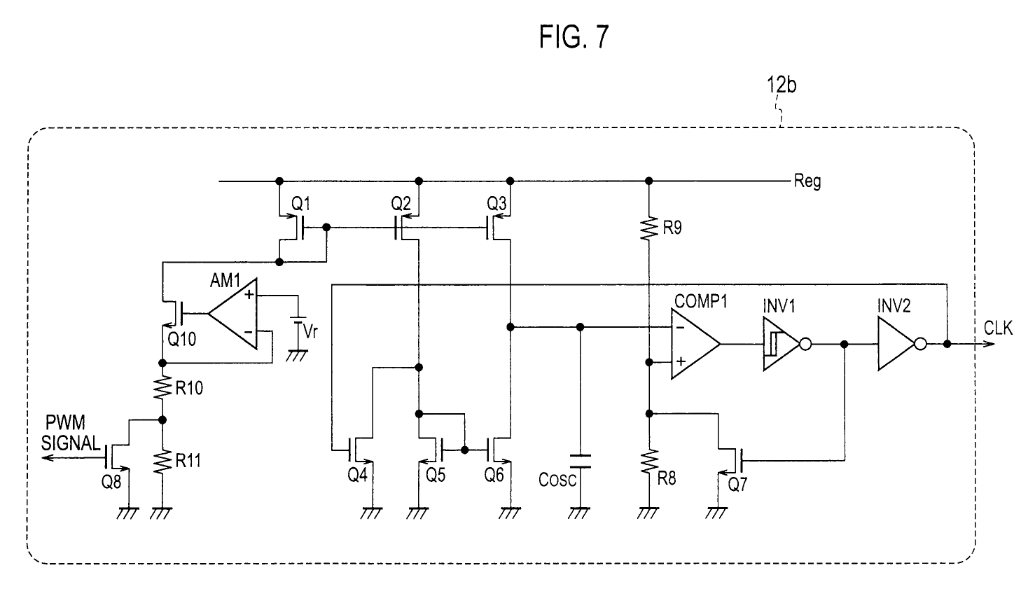

FIG. 7 is a view illustrating an oscillation circuit arranged in a power factor correction circuit according to Embodiment 3 of the present invention. The oscillation circuit 12b illustrated in FIG. 7 is characterized in that there are arranged an operational amplifier AM1, an FET Q10, and resistors R10 and R11 instead of the constant current sources Iosc and IADJ of the oscillation circuit 12 as illustrated in FIG. 3.

The drain of an FET Q1 is connected to the drain of the FET Q10, and the source of the FET Q10 is connected to an end of the resistor R10 and an inverting terminal (depicted by “−”) of the operational amplifier AM1. The other end of the resistor R10 is connected to an end of the resistor R11 and the drain of an FET Q8. The other ends of the resistor R11 and FET Q8 are grounded. A non-inverting terminal (depicted by “+”) of the operational amplifier AM1 is connected to a reference power source Vr and an output terminal of the operational amplifier AM1 is connected to the gate of the FET Q10. The operational amplifier AM1 and FET Q10 form a voltage follower. Due to this, a gate voltage of the FET Q10 is so set to equalize the voltage at the non-inverting terminal of the operational amplifier AM1 with a source voltage of the FET Q10.

With this configuration, the source voltage of the FET Q10 increases when the FET Q8 turns off, to increase a voltage at the inverting terminal of the operational amplifier AM1 and decrease the output voltage of the operational amplifier AM1, i.e., the gate voltage of the FET Q10. As results, a relatively small current passes through the FETs Q10 and Q1.

When the PWM signal turns on the FET Q8, the source voltage of the FET Q10 decreases to decrease the voltage at the inverting terminal of the operational amplifier AM1 and increase the output voltage of the operational amplifier AM1, i.e., the gate voltage of the FET Q10. This results in passing a relatively large current through the FETs Q10 and Q1. Namely, Embodiment 3 increases charging and discharging currents for an oscillation capacitor Cosc by turning on the FET Q8.

In this way, Embodiment 3 increases charging and discharging currents for the oscillation capacitor Cosc during an H-level period of the PWM signal, to change the frequency of the clock signal CLK of the oscillation circuit 12b, to provide the same effect as that provided by Embodiment 1.

According to Embodiments 1 to 3, a current passing through the FET Q3 of the first current mirror circuit is set to be equal to a current passing through the FET Q1. The same effect will be obtained if the current passing through the FET Q3 is set to be proportional to the current passing through the FET Q1. The constant current source IADJ may be a current source to provide a current that is not a constant current.

According to Embodiments 1 to 3, charging and discharging currents for the oscillation capacitor Cosc are changed according to the PWM signal. Instead, currents for the first and second current mirror circuits may be determined with different constant current sources and only the current of the first or second current mirror circuit may be changed according to the PWM signal. Although frequency variations become smaller, changing the current of the first current mirror circuit results in decreasing the discharging current for the oscillation capacitor in Embodiment 1 and increasing the same in Embodiment 2. This operation is opposite to the operation during a charging period. Depending on the setting of the duty factor of the oscillation circuit, the output frequency of the oscillation circuit can be increased or decreased.

According to Embodiments 1 to 3, charging and discharging currents for the oscillation capacitor Cosc are changed when the PWM signal is H-level. The same effect will be obtained by changing the charging and discharging currents for the oscillation capacitor Cosc when the PWM signal is L-level.

### EFFECT OF THE INVENTION

According to the first technical aspect of the present invention, the oscillation circuit changes the predetermined oscillation frequency of the clock signal according to the drive signal for the switching element. The power factor correction circuit of the CCM method changes the duty factor of the drive signal for the switching element according to the voltage of the AC power source, and therefore, the oscillation frequency of the oscillation circuit, i.e., the ON/OFF frequency of the drive signal for the switching element changes according to the voltage of the AC power source. As a result, the power factor correction circuit of this aspect diffuses noise to be generated, improves efficiency, and simplifies structure.

According to the second technical aspect of the present invention, the oscillation circuit increases or decreases charging and discharging currents for the oscillation capacitor by a predetermined value according to the drive signal for the switching element, thereby changing the oscillation frequency. This simplifies the structure of the power factor correction circuit and easily integrates the same into an IC.

### (United States Designation)

In connection with United States designation, this application claims benefit of priority under 35USC §119 to Japanese Patent Application No. 2007-121138 filed on May 1, 2007, the entire content of which is incorporated by reference herein.

1. A power factor correction circuit comprising:
a rectifier rectifying an AC voltage of an AC power source;
a first series circuit connected in parallel with an output of the rectifier and having a step-up reactor and a switching element those are connected in series;
a second series circuit connected in parallel with the switching element and having a rectifying diode and a smoothing capacitor those are connected in series;
an oscillator configured to generate a clock signal having a predetermined oscillation frequency; and
a control circuit configured to generate, at a period of the clock signal generated by the oscillator and according to a voltage value of the smoothing capacitor, a drive signal for driving the switching element, wherein
the oscillator changes the predetermined frequency according to the drive signal for the switching element.

2. The power factor correction circuit as set forth in claim 1, wherein the oscillator comprises:
an oscillation capacitor;
a signal generator configured to generate the clock signal having a predetermined oscillation frequency by repeatedly charging and discharging the oscillation capacitor; and
a frequency controller configured to change the predetermined oscillation frequency of the clock signal of the signal generator by increasing or decreasing, according to the drive signal for the switching element, at least one of charging and discharging currents for the oscillation capacitor by a predetermined value.
